(19) United States
(12) Patent Application Publication
(10) Pub. No.: US 2023/0093735 A1
(43) Pub. Date: Mar. 23, 2023

(54) METHOD AND SYSTEM FOR PROCESSING INCOMING EMAILS WHERE THE EMAIL IS PRESENTING A JOB OPPORTUNITY

(71) Applicant: Jobmail, LLC, Frisco, TX (US)

(72) Inventor: Howard W Cantrell, JR., Frisco, TX (US)

(73) Assignee: Jobmail, LLC, Frisco, TX (US)

(21) Appl. No.: 17/483,132

(22) Filed: Sep. 23, 2021

(51) Int. Cl. H04L 12/58; G06Q 10/10; G06F 16/16; G06F 16/11

(52) U.S. Cl. CPC H04L 51/02; H04L 51/12; G06Q 10/107; G06Q 10/1053; G06F 16/16; G06F 16/113

(57) ABSTRACT

A method for processing electronic messages is disclosed. The method includes setting a plurality of predetermined responses based on interest. The method includes storing the plurality of predetermined responses in accordance with one or more occupations in a memory. The method includes receiving a plurality of electronic messages from one or more senders. The method includes sorting the plurality of electronic messages by the one or more occupations. The method includes replying to the one or more electronic messages with a predetermined response in the plurality of predetermined responses.

### FIELD OF THE INVENTION

The present invention relates to the organization and filtering of electronic messages. More Specifically, the present invention discloses a method and system for processing and responding to electronic messages in an electronic mailbox

### BACKGROUND

The job searching process for job seekers has become even more complex and high paced that in previous job markets. Employers have more demanding requirements, timelines, and requests of potential hires. This is because employers and/or hiring entities require that they have a satisfactory workforce to meet the demands of doing business. In this regard, employers very often need to find or recruit new employees, replace former employees, find employees with new skills to meet their business needs, or obtain the services of temporary workers, independent contractors, or freelancers.

Due to these growing business and markets, it has become increasingly important for potential employees to find more ways to be more efficient in their job searching and recruitment activities. Accordingly, the job search process can often be rendered more difficult in instances when additional information may be requested by one or by both of the parties concerning a counterpart. This typically results in time delays and/or additional expense to the party having to comply with such a request. Additionally, job searching efforts and recruitment efforts may be limited by and/or be constrained by limited personal contacts, geographical constraints, monetary constraints, and/or time constraints. To combat this, there is a need for a system that allows for the potential hires or job searcher to sort through job opportunities and job offers more efficiently in order to more efficiently.

### SUMMARY

The apparatus and method of the present invention overcomes the shortcomings of the prior art and provides an apparatus and a method for providing job searching services, and an efficient way of responding recruitment advances and communications. The present invention utilizes various technologies and advances in information technology and in communication technology in order to provide these services in a network environment.

Several embodiments for processing electronic messages in an electronic mailbox are described herein. In one embodiment, a method for processing electronic messages is disclosed. The method includes setting a plurality of predetermined responses based on interest. The method includes storing the plurality of predetermined responses in accordance with one or more occupations in a memory. The method includes receiving a plurality of electronic messages from one or more senders. The method includes sorting the plurality of electronic messages by the one or more occupations. The method includes replying to the one or more electronic messages with a predetermined response in the plurality of predetermined responses.

In one embodiment, the one or more electronic messages comprises of an autonomous assignment by an electronic mail filter.

In one embodiment, the instant reply comprises of an interested or not interested message.

In one embodiment, the instant reply comprises of a request for additional information about a proposed job offer.

In one embodiment, the replying to the one or more electronic messages comprises of a manual assignment by a user.

In one embodiment, the one or more senders comprises of recruiters, job boards, human resources employees, and occupation managers.

In one embodiment, the sorting of the plurality of electronic messages comprises grouping the electronic message creates a conversation for a particular occupation.

In one embodiment, the sorting of the plurality of electronic messages comprises filtering the electronic messages in an interested folder or not interest folder, organized by job occupation.

In one embodiment, the sorting of the plurality of electronic messages comprises archiving one or more of the plurality of electronic messages based on the time of reply, interest in the job offer, timeline indicated in the electronic message, or level of interest.

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of an interchangeable double-sided attachment for an article. This description includes drawings, wherein:

FIG. 1 depicts a system diagram of processing an electronic message, in accordance with an embodiment.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### SPECIFICATION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Current job seekers are often bombarded with emails from recruiters, and various companies that are looking for in demand potential hires. In order to keep up with demand, and to provide a good impression to the employers and recruiters, it's become increasingly important for the job seekers to keep up with correspondences, respond with their best foot forward, and to make their job search more efficient to find the job role with the best fit. As such, job seekers rely on email systems and email providers in order to process large amounts of emails in order to help decrease their response time and process multiple job opportunity related emails in a short period of time. Often times, it's important for the job seeker to expedite their job search and hiring process by responding to emails effectively and efficiently and weeding out the best fit opportunities from the less desirable.

Current email providers are not focused on processing job search related emails. This method allows for the job seeker to easily reply, filter, sort and organize incoming job offer emails. They are limited to only focusing on providing emails to the customer, without actually helping expedite or efficiently process electronic messages in a way that reduces the amount of electronic messages in the user's inbox.

Accordingly, this disclosure provides for a method for processing electronic messages is disclosed. The method includes setting a plurality of predetermined responses based on interest. The method includes storing the plurality of predetermined responses in accordance with one or more occupations in a memory. The method includes receiving a plurality of electronic messages from one or more senders. The method includes sorting the plurality of electronic messages by the one or more occupations. The method includes replying to the one or more electronic messages with a predetermined response in the plurality of predetermined responses.

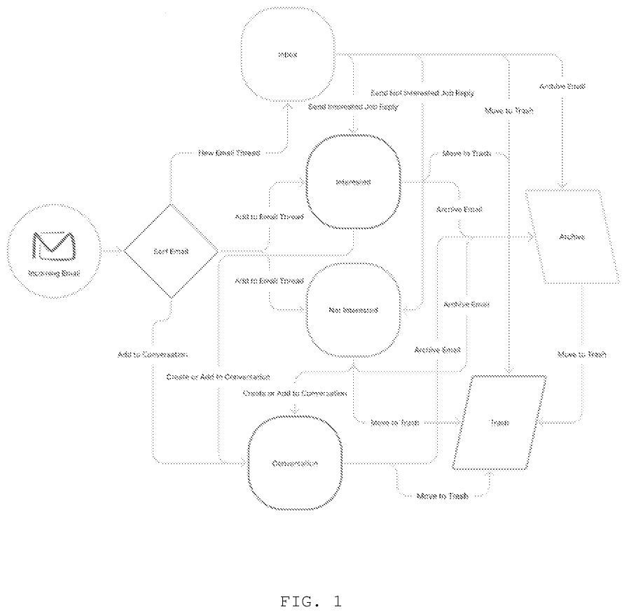

FIG. 1 depicts a system diagram incorporated into a method of processing an electronic message. The method starts with a recruiter contacting the job seeker through email by sending a job description, a request for additional information, or a request asking if the recipient is in the market for a new position or job opportunity via email. The system receives the email via a central processing hub configured to recognize job opportunity related emails, and sends the email to the recipient's inbox. The system can indicate to the recipient what type of job opportunity is contained within the email, and offer suggestions for reply. The suggestions can be determined based on one or more predetermined rules that are selected by the recipient. Based on the indication, the recipient can select from one or more options to quickly send a saved reply or move the email to the next stage of interested or not interested.

The interested emails can be selected to be instantly replied to with a saved job reply and moved to the Interested folder. This process can be completed manually or autonomously by one or more predetermined rules selected by the recipient, or by the system itself based on the user's prior actions on similar job types and job specifications. In addition, not interested emails can be instantly replied to with a saved job reply and moved to the Not interested folder. The saved job reply can be constructed in a template format by the recipient based on the type of job opportunity it is. The responses can range from content amount or conversation based on the email and job opportunity received. Accordingly, the system is designed to keep the Inbox empty and move each email to either Interested or Not interested folders.

From within the either Interested or Not interested folders the job seeker can send saved quick replies to gather more information about the job offer. The quick replies can be categorized and selected manually or autonomously by the user or system respectively. The quick replies can include one or more parameters of information based on information that is not currently known by the recipient intended to make the decision. The recipient can select one or more predetermined parameters based on the type of job opportunity or industry of interest. The system is configured to detect based on the content of one or more emails received from the recruiter which parameters have been determined and which of the parameters are still unknown. Accordingly, quick replies can be sent out based on the unknown parameters to gather additional information for the recipient in order to obtain additional information about the job opportunity. The parameters can be transmitted to a database configured to process the information received from the correspondence in the received emails, in order to rank the job opportunities based on interest requirements that are preset by the recipient. The interest requirements can include a desired salary range, location, distance from home, distance from points of interest, cost of living, job responsibilities, and reputation of the company. Based on the interest requirements met, or a closeness of the interest requirements met, each job opportunity and associated company can be ranked accordingly based on the most closely matching companies that would raise the most interest for the recipient. The database can submit a report into an email provider system via an application programming interface (API), allowing the recipient to approve or disapprove the ranking, or allocate additional quick replies to be sent to the recruiter.

The recipient job seeker can further group the electronic messages received into a conversation that indicates one or more next steps. When the job seeker would like to group the emails into a conversation and move to the next step, they can simply select the emails and create a conversion for that job offer. The conversation can be created based on the ranking, or manually selected by the user in accordance with additional requirements. Finally, if the job process is completed with either an offer, a denial or even a passing from the job seeker the conversation can be Archived or placed into the Trash.

The system as described above can be configured to use a create a software application that processes incoming emails and gathers all the required data and information. Accordingly, software logic can be implemented based on the rules stated above to be able to process the emails and allow the emails to be moved and sorted as described.

The above-described embodiments can be carried out by one or more user equipment or electronic devices. Ideally, the method can be carried out by a website or mobile device application. The website and mobile application and would be used to gather the required actions and data and received the notifications and data from the system. The best mode, but not the only mode applicable, for the system would be a Representational State Transfer (REST) software application setup on web servers, to be able to send and receive data from the website and/or mobile application.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A method for processing electronic messages in an electronic mailbox, the method comprising:
setting a plurality of predetermined responses based on interest;
storing the plurality of predetermined responses in accordance with one or more occupations in a memory;
receiving a plurality of electronic messages from one or more senders;
sorting the plurality of electronic messages by the one or more occupations;
replying to the one or more electronic messages with a predetermined response in the plurality of predetermined responses.

2. The method of claim 1, wherein the replying to the one or more electronic messages comprises of an autonomous assignment by an electronic mail filter.

3. The method of claim 2, wherein the autonomous assignment by the electronic mail filter comprises an instant reply.

4. The method of claim 3, wherein the instant reply comprises of an interested or not interested message.

5. The method of claim 3, wherein the instant reply comprises of a request for additional information about a proposed job offer.

6. The method of claim 1, wherein the replying to the one or more electronic messages comprises of a manual assignment by a user.

7. The method of claim 1, wherein the one or more senders comprises of recruiters, job boards, human resources employees, and occupation managers.

8. The method of claim 1, wherein the sorting of the plurality of electronic messages comprises grouping the electronic message creates a conversation for a particular occupation.

9. The method of claim 1, wherein the sorting of the plurality of electronic messages comprises filtering the electronic messages in an interested folder or not interest folder, organized by job occupation.

10. The method of claim 1, wherein the sorting of the plurality of electronic messages comprises archiving one or more of the plurality of electronic messages based on the time of reply, interest in the job offer, timeline indicated in the electronic message, or level of interest.
